(19) United States
(12) Patent Application Publication
(10) Pub. No.: US 2007/0122784 A1
(43) Pub. Date: May 31, 2007

(54) Test lung devices

(76) Inventor: Mario Carvajal, Temecula, CA (US)

Correspondence Address: LAW OFFICE OF MICHAEL P. EDDY;MICHAEL P. EDDY, 12526 HIGH BLUFF DRIVE, STE. 300, SAN DIEGO, CA, 92130, US

(21) Appl. No.: 11/435,391

(22) Filed: May 15, 2006

Related U.S. Application Data
(60) Provisional application No. 60/680,737, filed on May 13, 2005.

(51) Int. Cl. G09B 23/28

(52) U.S. Cl. 434/267; 434/256

(57) ABSTRACT

A device used to simulate the characteristics of a multi chambered lung consisting of at least two air chambers, each chamber having a first and second interconnected panel portions, an inflatable bag positioned between said first and second panel portions so that the inflatable bag is interposed therebetween and an air interface connected to said the chambers for allowing air to be exchanged with an external device. The interconnected panel portions flex as the bag is inflated and they also provide a restoring force that deflates the bag when the squeezing force is removed. The panel portions corresponding to each of the multiple air chambers are also interconnected by connecting panel portions that provide mechanical coupling between the plurality of air chambers.

### CROSS-REFERENCES TO OTHER RELATED PATENT APPLICATIONS

This application claims the benefit of U.S. Provisional Application Ser No. 60/680,737 filed May and 13, 2005 and U.S. Provisional Application Ser. No. ______ filed May 15, 2006 which are incorporated herein by reference in their entireties.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISK APPENDIX

Not Applicable.

### BACKGROUND

Embodiments of the claimed subject matter relate generally to lung simulators which are used with ventilators for training, testing and troubleshooting. More particularly, the embodiments relate to devices and methods used to simulate human or other animal lungs and to test how lung simulators can be coupled to a ventilator. Test lung devices simulate certain aspects of human or animal lungs which allow for training of medical technicians as well as the testing and troubleshooting of ventilators without having to use human or animal subjects.

### SUMMARY

One aspect of the present teachings relates to a test lung device that includes a plurality of air chambers. Each chamber includes an inflatable bag, and the plurality of inflatable bags of the plurality of air chambers are coupled to an air interface that connects to an external device. Each chamber further includes first and second interconnected panel portions positioned so that the inflatable bag is interposed therebetween. The interconnected panel portions flex as the bag is inflated, and the flexing panel portions provide a restoring force that deflates the bag_ Such panel portions corresponding to the plurality of air chambers are interconnected by connecting panel portions that provide mechanical coupling between the plurality of air chambers.

Another aspect of the present teachings relates to an air chamber of a test lung device. The air chamber includes an inflatable bag that has a deformable and restorable insert therein. The insert inhibits the inflatable bag from collapsing when in a relaxed configuration. The bag can be collapsed by squeezing the bag. The restorative property of the insert restores the bag to its non-collapsed relaxed configuration when the squeezing force is removed. As the bag is restored to its relaxed configuration, a negative pressure situation is created temporarily in the air chamber.

Yet another aspect of the present teachings relates to a flow adapter for coupling a test lung device to a ventilator. The flow adapter includes a plurality of tubular members having first and second ends. Each tubular member defines first and second spaces adjacent the first and second ends. Each tubular member further defines a partition that is positioned between the first and second spaces. The partition defines an aperture that allows air to flow between the first and second spaces. The first and second spaces of the plurality of tubular members are dimension to receive air interface portions of the test lung device and the ventilator. The apertures of the plurality of tubular members can be dimensioned differently so as to provide different flow rates for different tubular members.

### BRIEF DESCRIPTION OF THE DRAWINGS

FIG. 1 shows one embodiment of a test lung assembly coupled to ventilator hoses via one embodiment of a flow adapter having a plurality of conduits having different flow characteristics;

FIG. 2 shows a partially unassembled view of FIG. 1;

FIG. 3 shows the test lung and the flow adapter in a coupled configuration;

FIG. 4 shows a close-up of an uncoupled configuration of the test lung and the flow adapter;

FIG. 5 shows an isolated view of one embodiment of the flow adapter, showing that different flow characteristics of the plurality of conduits can be achieved by different sized restricting apertures;

FIG. 6 shows an isolated view of one embodiment of a coupler that couples ventilator hoses to one of the conduits of the flow adapter;

FIG. 7 shows an isolated view of one embodiment of a test lung having two or more air chambers;

FIG. 8 shows a partially unassembled view of the test lung of FIG. 7, showing that the air chambers include separate expandable bags that are Y-coupled to allow coupling to one of the conduits of the flow adapter;

FIG. 9 shows an isolated breakaway view of one embodiment of a flexible panel that can be shaped to accommodate the expandable bags as they expand and contract;

FIG. 10 shows an isolated view of one embodiment of the expandable bag; and

FIGS. 11A and 11B show cross-sectional views of one embodiment of an expandable bag having an insert that allows generation of a negative pressure in the bag;

FIG. 12 illustrates a top view of another embodiment of the air interface;

FIG. 13 illustrates a side view of the embodiment of FIG. 12;

FIG. 14 is a front side perspective view of an embodiment of the air interface.

FIG. 15A is a top perspective view of an embodiment of the annulate accommodating air interface with the annulate removed.

FIG. 15B is a top perspective view of an embodiment of the annulate.

These and other aspects, advantages, and novel features of the present teachings will become apparent upon reading the following detailed description and upon reference to the accompanying drawings. In the drawings, similar elements have similar reference numerals.

### DETAILED DESCRIPTION OF THE EMBODIMENTS

With reference now to the various figures in which identical elements are numbered identically throughout, a description of various exemplary aspects of the claimed subject matter will now be provided.

The present teachings relate to a test lung assembly, and also how any test lungs can be coupled to a ventilator. As is known, test lung devices simulate certain aspects of human lungs, thereby allowing testing of ventilators without having to rely on human subjects. For the purpose of description herein, “air” can refer to any gas compound or mixture that can be used with ventilators.

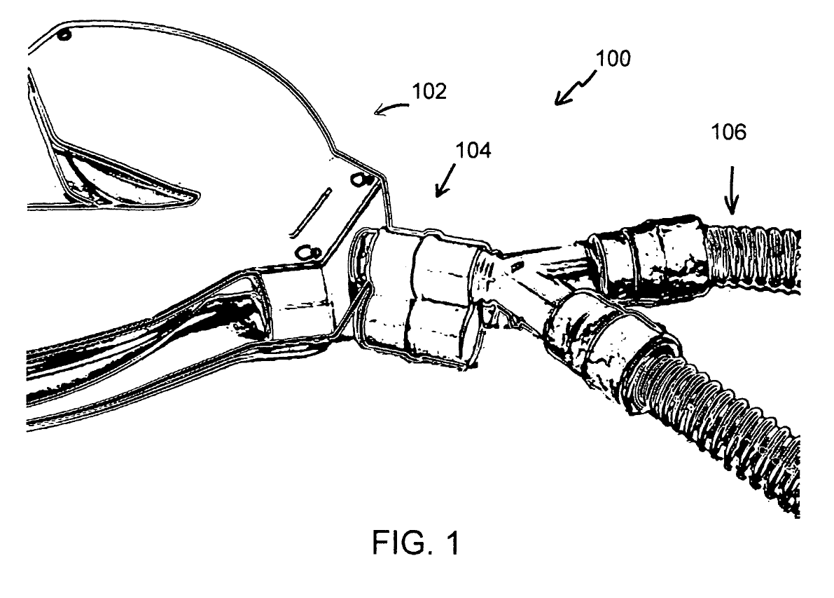

FIG. 1 shows one embodiment of an assembly 100 having a test lung 102 coupled to ventilator hoses 106 via a flow adapter 104. The test lung 102 and the flow adapter 104 are described below in greater detail.

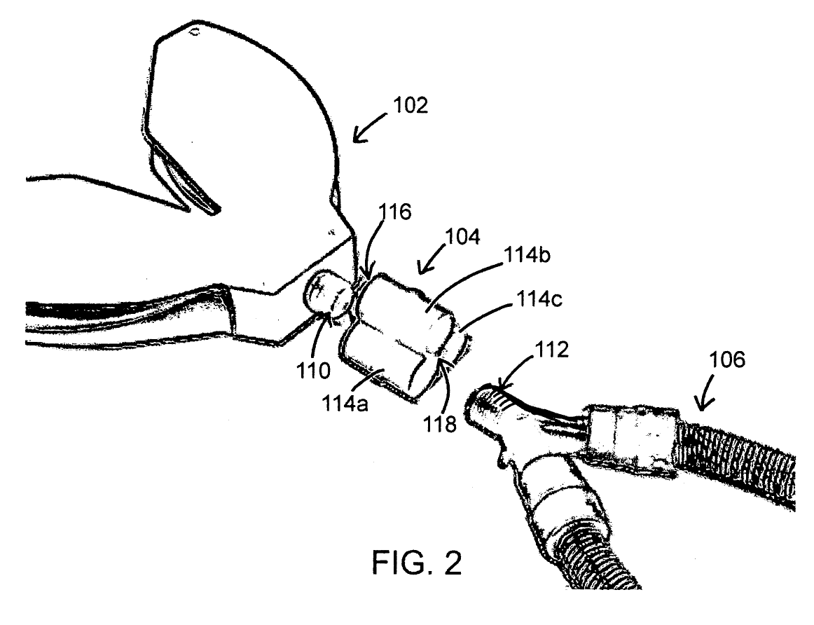

FIG. 2 shows the assembly of FIG. 1 in a partially unassembled configuration. As shown, the test lung 102 includes a test lung air interface 110. As also shown, the ventilator hoses 106 can be Y-coupled by a coupler having a ventilator air interface 112.

As further shown in FIG. 2, the flow adapter 104 includes a plurality of tubular members 114a, 114b, 114c that extend in a generally parallel manner, so as to define a first end 116 and a second end 118. In one embodiment as shown in FIG. 2, the flow adapter 104 includes three tubular members coupled to each other in a substantially fixed manner so as to form a closely-packed type configuration. In other embodiments, the tubular members are not necessarily attached to each other in a fixed manner. Also, other embodiments may have more than three, or less than three tubular members. Also, other embodiments may have the tubular members arranged in a non-closepacked configuration.

Each of the example tubular members 114a, 114b, 114c defines a first space adjacent the first end 116, and a second space adjacent the second end 118. In one embodiment, each of the tubular members 114a, 114b, 114c can have a cross-sectional shape that is substantially circular, such that the first and second spaces have a generally cylindrical shape. In one embodiment, the first and second spaces can be dimensioned to receive the test lung air interface 110 and the ventilator air interface 112, respectively.

Additionally, the diameters of the test lung air interface 110 can be selected to be approximately same as that of the ventilator air interface 112, and the first and second spaces can be dimensioned accordingly, so that the first end 116 can be interchanged with the second end 118.

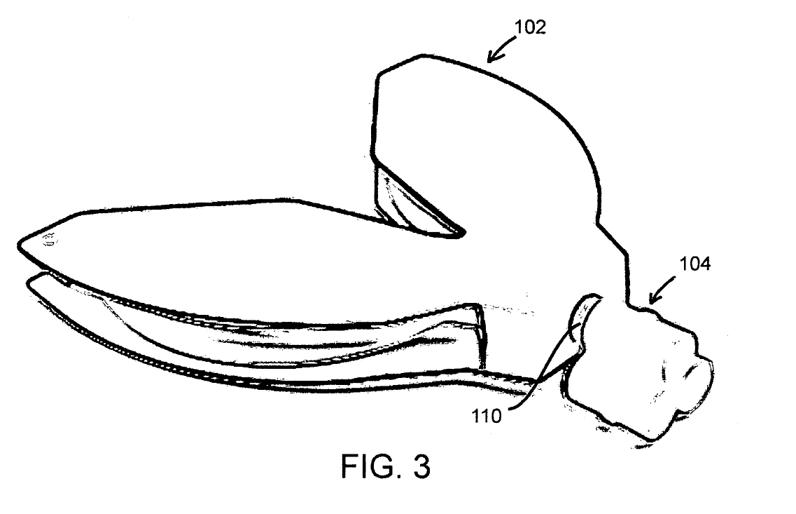

FIG. 3 shows a view of the flow adapter 104 coupled to the test lung 102 via the air interface 110. As described herein, such a coupling allows air to flow in and out of the test lung 102 in a generally regulated manner. Furthermore, as also described herein, the test lung 102 having a plurality of air chambers provides flexibility in the manner in which the test lung 102 can be utilized in testing a given respirator.

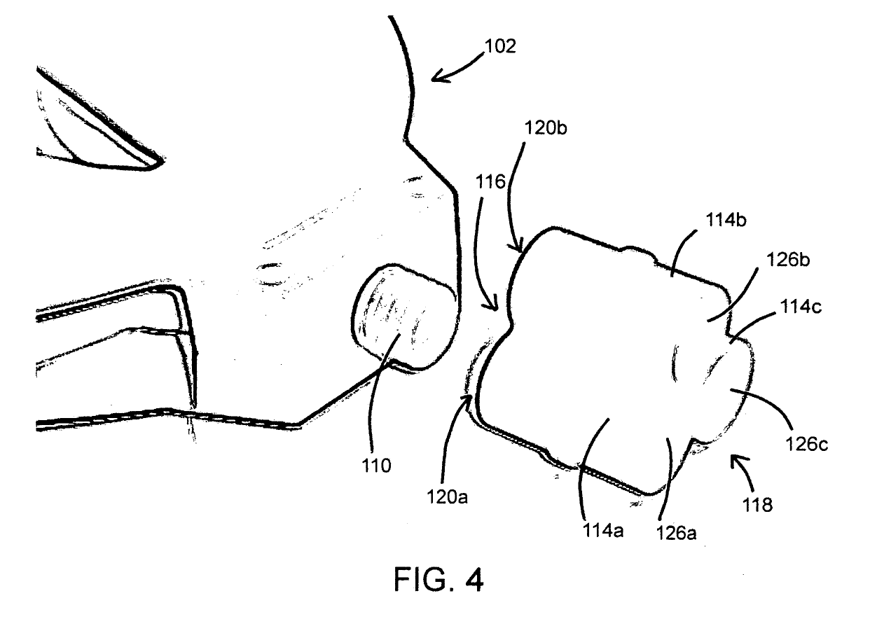

FIG. 4 shows a closer unassembled view of the coupling between the test lung 102 and the flow adapter 104. In one embodiment, as described above, the test lung air interface 110 can be dimensioned to fit into one of the plurality of spaces defined adjacent the first end 116 (or the second end 118 in the interchangeable-end embodiment). Thus, the test lung interface 110 inserted in a first space 120a adjacent the first end 116 is air-coupled to a second space 126a adjacent the second end 118; and a ventilator air interface (not shown) inserted into the second space 126a would then be air-coupled to the test lung 102. Similar air-coupling can be achieved using the combinations of spaces 120b/126b and 120c/126c (126c hidden from view).

The foregoing arrangement can provide for different flow rates between the test lung 102 and the ventilator at the flow adapter 104. FIG. 5 shows one example of how such different flow rates can be achieved. In one embodiment as shown in FIG. 5, each of the tubular members 114a, 114b, 114c define first and second spaces 120, 126 (second spaces 126 not shown in FIG. 5). In one embodiment, each of the tubular members 114a, 114b, 114c includes a partition 122 interposed between the first and second spaces 120, 126. Each partition 122 defines an aperture 124 that allows flow of air between the first and second spaces 120, 126. The apertures 124 can be dimensioned differently to allow different flow rate of air.

In an embodiment shown in FIG. 5, the first partition 122a defines the first aperture 124a having a first dimension. The second partition 122b defines the second aperture 124b having a second dimension that is larger than the first dimension, thereby allowing a greater air flow than the first aperture 124a. Similarly, the third partition 122c defines the third aperture 124c having a third dimension that is larger than the second dimension, thereby allowing a greater air flow than the second aperture 124b.

In one embodiment, the partitions 122 can be positioned at an approximately midpoint between the first and second ends 116, 118, such that the first and second spaces 120, 126 are substantially similar for a given tubular member 114. For such an embodiment, either of the first and second spaces 120, 126 can receive either of the air interfaces (110 for the test lung, and 112 for the ventilator).

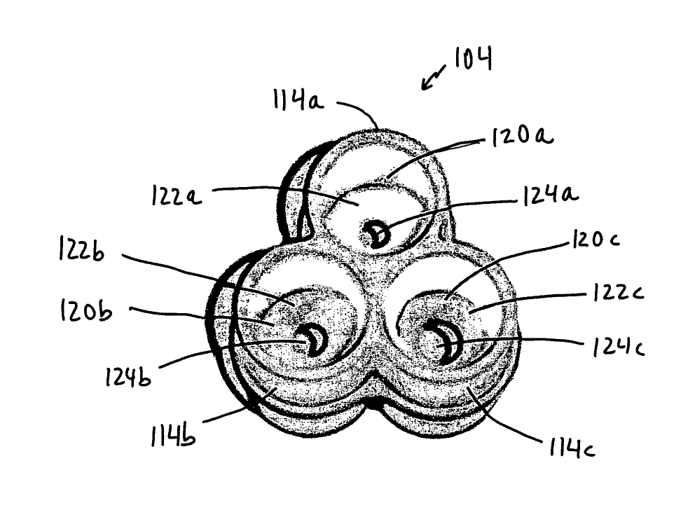

FIG. 6 shows one embodiment of a coupler 130 having the air interface (112 or 110) that is dimensioned to fit into the foregoing first or second space 120, 126. The air interface (112 or 110) is shown to be split into a first conduit 132 and a second conduit 134 so as to form a “Y” shaped coupling. Such a coupling allows the air interface (112 or 110) to be coupled to two air conduits (such as two ventilator hoses or two air chambers.) Of course, if there are more than two conduits, then the air interface can be split into more-than two conduits. Not shown is an additional embodiment that includes one or more resistors disposed within one or more conduits 132 or 134 so as to provide increased resistance to one or both of the air flows. In use, one or more resistors may be used to simulate the resistive load of one or more particular air chambers at a time or one portion of the air chamber or air flow at a time. This allows the testing of air flow in a variety of different configurations for testing, training or troubleshooting a variety of real world conditions.

In one embodiment, the coupler 130 can provide a similar “Y”-coupling functionality on both the test lung side and the ventilator side. In one embodiment, substantially similar couplers 130 couple both the test lung and the ventilator to the flow adapter 104. In another embodiment, the test lung side coupler 130 has a different dimension than the ventilator side coupler 130.

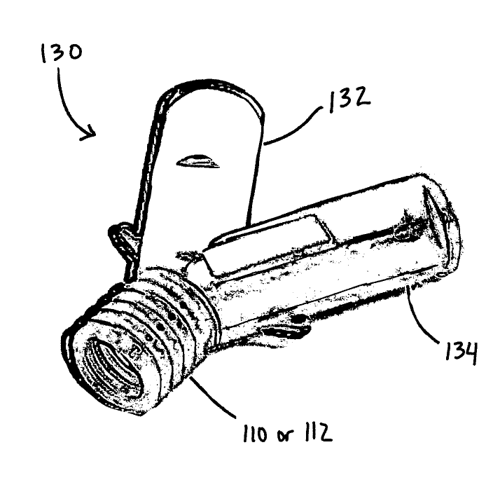

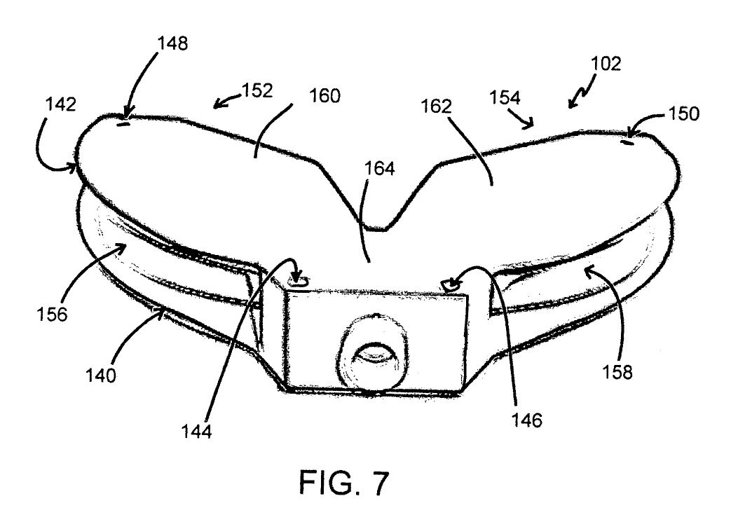

FIG. 7 shows an isolated view of the example test lung 102 having a first air chamber 152 and a second air chamber 154. In one embodiment as described below in greater detail, the first and second air chambers 152, 154 are coupled to the flow adapter 104 via a “Y” shaped coupler.

In one embodiment, the first air chamber 152 includes a first expandable bag 156, and the second air chamber 154 includes a second expandable bag 158. The first and second expandable bags 156, 158 are interposed between a first panel member 140 and a second panel member 142. In one embodiment, the first and second panel members 140, 142 are interconnected at locations 148 (on the first air chamber side), 150 (on the second air chamber side), and 144, 146 (between the first and second air chambers). Thus, the first and second panel members 140, 142 partially constrain the bags 156, 158 as the bags expand and contract due to the operation of the ventilator.

In one embodiment, each of the first and second panel members 140, 142 defines a first panel portion 160 and a second panel portion 162. The first and second panel portions 160, 162 can be interconnected by a connecting panel portion 164. One can see that the interconnecting panel portion 164 can be dimensioned differently to provide different mechanical interconnecting property between the first and second panel portions 160, 162. For example, a larger area of the interconnecting panel portion 164 can increase the mechanical coupling between the first and second panel portions 160 and 162. Conversely, a smaller area of the interconnecting panel portion 164 can decrease the mechanical coupling between the first and second panel portions 160, 162. Based on the foregoing mechanical coupling of the first and second panel portions 160, 162, one can see that the constraining property of the first and second panel members 140, 142 (as the bags expand and contract) can be selected to provide a desired configuration. In other embodiments additional walls may be used to provide increased resistance in the inflation of the bags or decreased compliance of the lung load such as in a simulated situation of the breakdown of lung capacity.

As shown in FIG. 7, the first and second panel members 140, 142 can be interconnected to each other via a plurality of interconnections, such as those indicated as 144, 146, 148, 150. With such example interconnections, the first and second panel members 140, 142 can maintain a substantially relaxed configuration when the bags 156, 158 are deflated. As the bags 156, 158 become inflated, the panel portions 160, 162 of the first and second panel members 140, 142 can bulge out. That is, the first panel portions 160 of the first and second panel members 140, 142 bulge away from each other at locations between the interconnections 148 and 144. Similarly, the second panel portions 162 of the first and second panel members 140, 142 bulge away from each other at locations between the interconnections 150 and 146.

In one embodiment, the first and second panel members 140, 142 are formed from a flexible panel so as to facilitate the foregoing bulging. When bulged, the panel portions 160, 162, in conjunction with the interconnections 144, 146, 148, 150, can provide a restorative force so as to induce deflation of the bags 156, 158, thereby simulating the function of a lung. In one embodiment, the first and second panel members 140, 142 are configured so as to provide the deflating restorative force when the bags 156, 158 are substantially far within their elastic limit. Because the bags do not need to stretch much to provide the “exhale” portion, one can see that the useful “lifetime” of the bags can be improved.

As described above, the first and second panel portions 160, 162 can mechanically coupled by the interconnecting panel portion 164. As the test lung operates (expansion-relaxation cycles), the mechanically-coupled air chambers 152, 154 can provide a significantly greater ranges and types of mechanical responses than a single-chamber devices or devices where the air chambers are substantially independent.

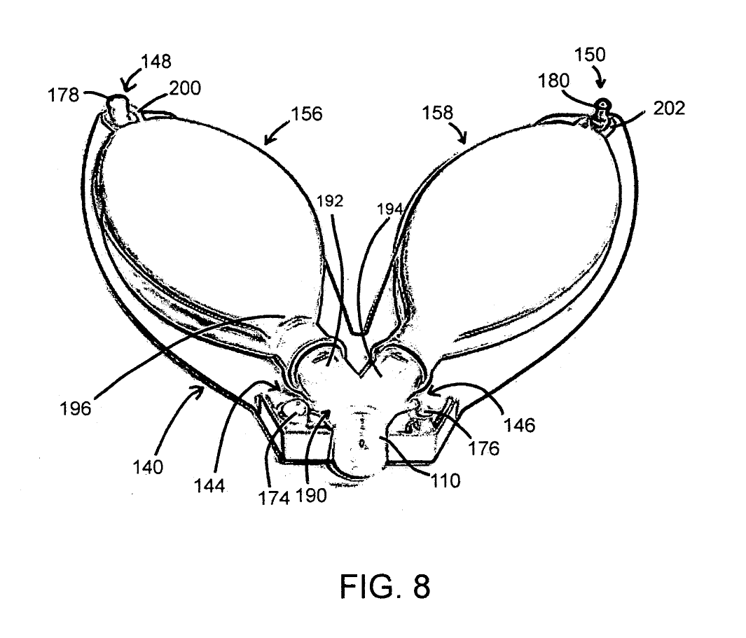

FIG. 8 shows a partially unassembled view of the example test lung of FIG. 7, showing by example how the bags 156, 158 can be installed and coupled to the air interface 110. FIG. 8 also shows how the example interconnections 144, 146, 148, 150 can be configured to allow a quick assembly of the first and second panel members 140, 142.

In one embodiment of the first panel member 140 as shown in FIG. 8, the example interconnection 144 defines a recess 174 that is dimensioned to receive a protrusion similar to a protrusion 176 of the interconnection 146. Similarly, the example interconnection 148 defines a recess 178 that is dimensioned to receive a protrusion similar to a protrusion 180 of the interconnection 150. In one embodiment, the second panel member 142 (not shown) can be substantially similar to the first panel member 140, such that when being assembled facing each other, the recess 174 of the first panel member 140 receives the protrusion 176 of the second panel member 142, and so on. In one embodiment, such matching recesses and protrusions are dimensions so as to allow snap-fitting, such that the first and second panel members 140, 142 can be assembly by simply snapping the matching interconnections together.

In one embodiment as shown in FIG. 8, the bags 156, 158 include loops 200 and 202 which are positioned generally opposite from their mouths 196, 198. The first and second panel members 140, 142 can be dimensioned to generally accommodate the bags 156, 158, and the interconnections 148, 150 can be positioned so as to allow retaining of the loops 200, 202. The mouth ends 196, 198 are shown to receive first and second conduits 192, 194 of one embodiment of a Y-coupler 190, such that the first and second bags 156, 158 can be air-coupled to the air interface 110. In addition to providing the air-coupling, the Y-coupler 190 can be retained by the first and second panel members 140, 142, thereby retaining the bags 156, 158.

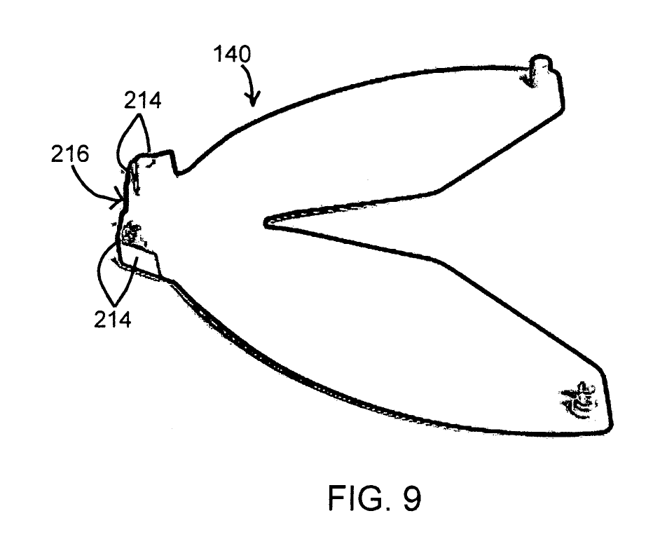

FIG. 9 shows an isolated view of the example panel member 140. In one embodiment, the panel member 140 includes a plurality of walls 214 about the air interface (110, not shown) end. A portion of the walls 214 is shown to define a cutout 216 dimensioned to receive the air interface 110 portion of the Y-coupler 190. Thus, when the first and second panel members 140, 142 are assembled, the Y-coupler 190 can be retained by the walls 214.

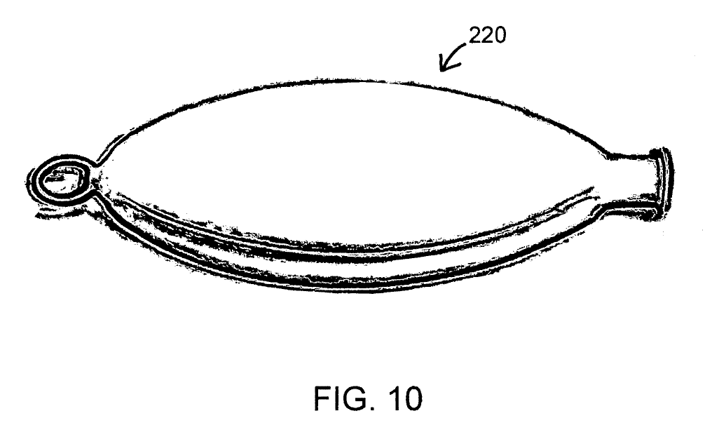

FIG. 10 shows an isolated view of one embodiment of a bag 220 that can be used in the test lung described herein. In one embodiment, the bag 220 is substantially hollow inside. In another embodiment, the bag 220 includes an insert that provides a relaxed configuration where the bag 220 is not collapsed. While the hollow bag 220 can be in a non-collapsed configuration, it may not be consistent. For example, if the bag 220 is squeezed, it may not recover to the non-collapsed configuration. On the other hand, the insert can provide the non-collapsed relaxed configuration in a generally consistent manner. The non-collapsed configuration of the bag 220 can provide a negative pressure situation, where the action of the bag draws air inward. Such a feature can be useful in testing a triggering mechanism of a ventilator.

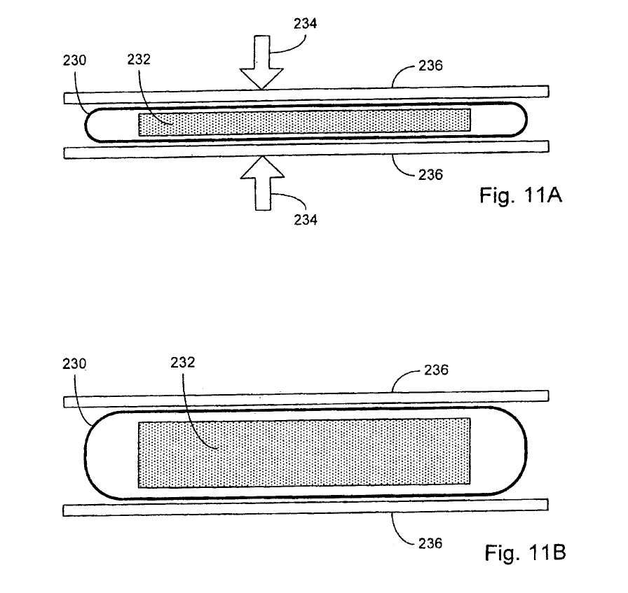

FIGS. 11A and 11B show cross-sectional views of one embodiment of a bag 230 having an insert 232. In FIG. 11A, the bag 230 is shown to be in a squeezed configuration such that the overall inside air volume is reduced. Such squeezed configuration can be achieved by, for example, an operator squeezing (depicted as arrows 234) the panels (236) of the corresponding air chamber of the test lung.

In FIG. 11B, the bag 230 is shown to substantially restore itself to its relaxed configuration due to the insert restoring itself when the squeezing force is removed. As the bag restores itself, the air volume is increased, thereby creating a temporary negative pressure situation. In one embodiment, the insert 232 can be formed from materials such a foam that has mechanical restorative properties. Other embodiments may use any other suitable material such as sponge, rubber or silicone. A latex free foam may be used in other embodiments.

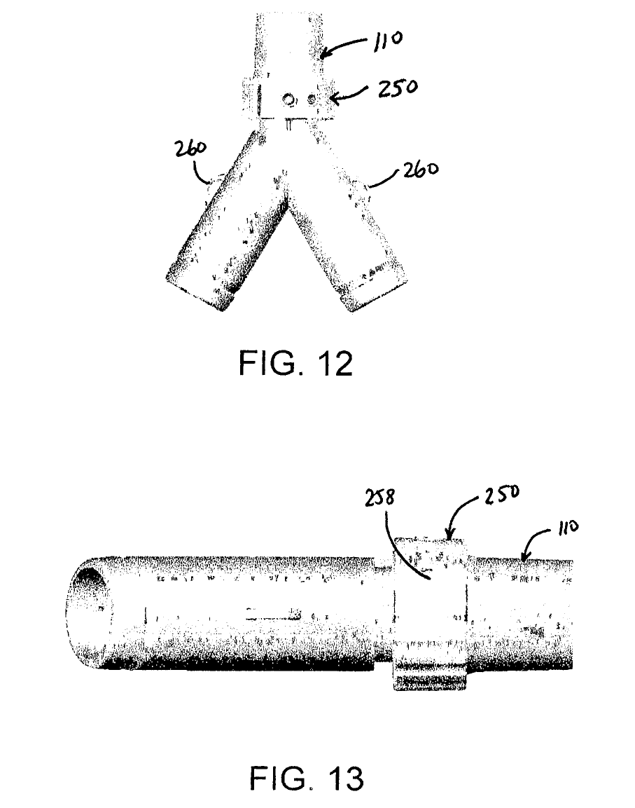

FIG. 12 illustrates a top view of another embodiment of the air interface 110 having an annulet 250 employed to close or open an aperture 252. The annulate 250 is slidably disposed over the surface of the air interface 100. When turned by the user, it covers or uncovers one or more apertures 252. When uncovered, aperture 252 allows air to flow out of the air interface 100 into the environment simulating an air leak.

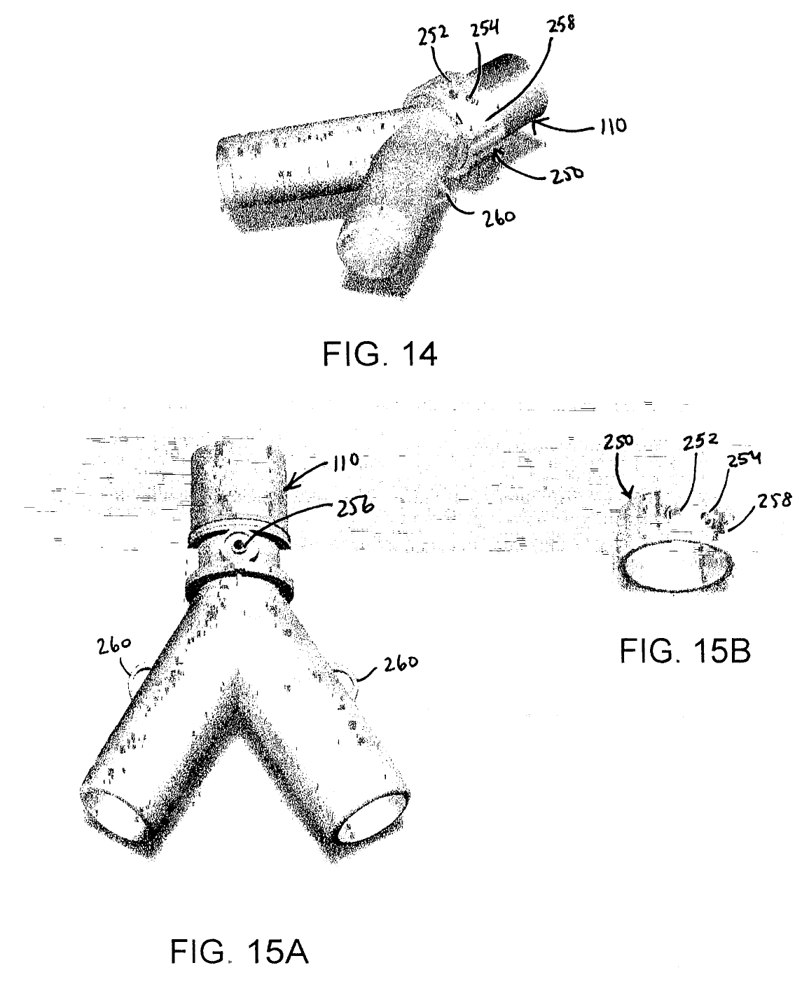

FIG. 13 illustrates a side view of the embodiment of FIG. 12 with the annulate 250 slidably engaged along the surface of the air interface 110. In use, annulate 250 can be snapped into place and set to restrict air flow or allow air flow to leak into the environment. A no leak position for annulate 250 is indicated as numeral 258 in FIG. 13. FIG. 14 is a front side perspective view of the air interface 110 and annulate 250 of FIGS. 12 and 13. FIG. 14 also illustrates a lanyard tether 260 which can be used to secure the air interface 110. Tether 260 can also be disposed on any other component of the embodiments of the claimed subject matter, for example the coupler 130 and/or the ventilator interface 112. FIG. 15A is a top perspective view of the annulate showing the air interface 110 with aperture 256 exposed and annulate 250 removed. Aperture 256 can be aligned with one or more apertures found in the annulate 250 so that air can flow at varying rates from air interface 100 into the environment. FIG. 15B is a top perspective view of an embodiment of annulate 250 showing two apertures, aperture 252 and 254 having differing diameters so that the rate of air flow can be varied depending on the aperture selected by the user.

In another embodiment, one or more annulate 250 and one or more apertures 252 or 254 may be accommodated within and disposed on one or more of the tubular members 114. The annulate 250 in other embodiments may be a partial annulate and the aperture 252 may be of any suitable diameter. A no leak position on an air intake 110 or a tubular member 114 may also be provided to indicate the position in which the annulate will cover the apertures 252 so no loss of air will occur.

Embodiments of the claimed subject matter can be used to simulate a large amount of varying quantities of breaths, for example from 25 mL to 2.5 Liters. They can also be used with varying ventilation and triggering modes. The size of embodiments can similarly vary according to the needs of the users. For example, embodiments can be used in neonatal sized, adult sizes or any other variation. Embodiments may also be easily transported in small cases. One embodiment has dimensions of 10.5×11.5×1.5 includes allowing it to fit in a standard sized suitcase.

Embodiments also include various modes such as volume and pressure control. Triggers include but are not limited to the flow trigger and the pressure trigger. In some embodiments the usable pressure can vary greatly, for example from 0 to 120 cmH₂O. The sensitivity can also vary, for example from 0 to −20 cmH₂O so that embodiments may be used with any commercially available ventilator.

Example resistances of the coupler 130 includes conduits with resistances of Rp5 cmH₂O/l/s (for example used for Vt>300 ml,) Rp20 cmH₂O/l/s (for example in use for Vt 30-300 ml,) and Rp50 cmH₂O/l/s (for example used for Vt<30 ml.) Any other suitable resistance may be used with the one or more conduits 132 or 134 in the coupler 130.

Although the above-disclosed embodiments have shown, described and pointed out the fundamental novel features of the claimed subject matter as applied to the above-disclosed embodiments, it should be understood that various omissions, substitutions, and changes in the form of the detail of the devices, systems and/or methods shown may be made by those skilled in the art without departing from the scope of the claimed subject matter. Consequently, the scope of the claimed subject matter should not be limited to the forgoing description.

What is claimed is:

1. A test lung device for simulating a multi chambered lung comprising:
at least two air chambers, each chamber having
a first and second interconnected panel portions;
an inflatable bag positioned between said first and second panel portions so that the inflatable bag is interposed therebetween; and
an air interface connected to said the chambers for allowing air to be exchanged with an external device;
wherein the interconnected panel portions flex as the bag is inflated;
wherein the interconnected panel portions provide a restoring force that deflates the bag;
and wherein the panel portions corresponding to each of the multiple air chambers are interconnected by one or more connecting panel portions that provide mechanical coupling between the plurality of air chambers.

2. The test lung device of claim 1, wherein the inflatable bag includes an insert which is both deformable and restorable for inhibiting the bag from collapsing when the bag is forcibly squeezed and for aiding in the restoring of the bag to the bag's non-collapsed configuration when the squeezing force is removed thereby creating an amount of negative pressure within the chamber for a variable period of time.

3. The test lung device of claim 2, wherein the insert is constructed of one or more pieces of foam.

4. The test lung device of claim 1, wherein the inflatable bag includes a tether loop for securing the inflatable bag to one or more of the panel portions.

5. The test lung device of claim 1, wherein the air intake is further comprised of at least one aperture disposed on the body of said air interface and one or more annulets slidably disposed on the surface of the one or more portions of said air interface for opening and closing said one or more apertures so that when an aperture is opened, air flows out of the test lung device.

6. The test lung device of claim 1, wherein the air interface is split into more than two conduits.

7. The test lung device of claim 1, wherein one or both of the first and second interconnected panel portions and inflatable bags are restricted by additional walls positioned opposite to the air interface.

8. The test lung device of claim 1, wherein a resistor is added to one or more conduits wherein the air flow is restricted.

9. A flow adapter for coupling a test lung device to a ventilator comprising:
at least two tubular members each having:
a first and a second end defining a first and a second space adjacent to the first and second ends with a partition disposed between said first and second ends;
said partition defining an aperture that allows air to flow between said first and second ends;
wherein the apertures of said first and second spaces of a tubular member are independently dimensioned to receive air interface portions of the test lung device and the ventilator.

10. A flow adapter of claim 9 wherein the apertures of said first and second spaces of two or more tubular members are different in diameter.

11. A flow adapter of claim 9 wherein the tubular members are different in diameter.
